(19) United States
(12) Patent Application Publication
(10) Pub. No.: US 2012/0312328 A1
(43) Pub. Date: Dec. 13, 2012

(54) Apparatus, method and system for cleaning detectors

(76) Inventor: Richard A. Chavez, Los Lunas, NM (US)

(21) Appl. No.: 13/507,171

(22) Filed: Jun. 11, 2012

Related U.S. Application Data
(60) Provisional application No. 61/520,566, filed on Jun. 10, 2011.

(51) Int. Cl. A47L 9/02; B08B 5/04

(52) U.S. Cl. 134/21; 15/414

(57) ABSTRACT

A detector cleaner generally defined as a funnel structure with a preferably integrally formed wide surface area on one end, and an integrally formed narrow surface area on the opposite end, the funnel structure further having an interior void V or funnel channel where the wide area of the funnel structure is adapted to be placed over a detector to thereby completely encapsulate the detector. The narrow area of the funnel structure is adapted to be removeably connectable to a suction means (such as a vacuum machine) through a vacuum connection. Preferably, one or more angled holes are formed variously on the funnel structure so that when the suction means is engaged, the exterior air or other fluid flowing through each angled hole will dramatically enter the interior of the funnel to thereby create a significant fluid cyclone or swirling effect within the interior chamber of the funnel structure.

### CLAIM OF PRIORITY

The present invention claims the benefit and priority of U.S. Provisional Patent Application No. 61/520,566 filed on Jun. 10, 2011, titled “Apparatus, Method And System For Cleaning Detectors”.

### FIELD OF INVENTION

The present invention is generally directed towards detectors, and more specifically, those detectors used to detect any type of fluid (including, but not limited to, carbon dioxide, carbon monoxide, smoke and/or heat) and providing an alarm to alert that potential danger exists.

### BACKGROUND OF THE INVENTION

Almost all households in the U.S. have at least one smoke alarm, yet between the years of 2000-2004, no smoke alarms were present or none operated in almost half (46%) of the reported home fires (homes include one- and two-family dwellings, apartments and manufactured housing). These estimates are based on data from the U.S. Fire Administration's (USFA's) National Fire Incident Reporting System (NFIRS) and the National Fire Protection Association's (NFPA's) annual fire department experience survey. This data is a summary of NFPA's April 2007 report, U.S. Experience with Smoke Alarms and Other fire Detection/Alarm Equipment by the same author.

During the same period, 43% of all home fire deaths resulted from fires in homes with no smoke detector alarms, while 22% resulted from homes in which smoke detector alarms were present but did not operate for any number of reasons. For example, nuisance alarms are a leading cause of disabled alarms. Nuisance alarms are a serious problem because if a smoke detector alarm (for example) repeatedly sounds when there is no fire, the owner is likely to disable the detector, but the detector will not operate should a real fire or other alarm event arise. When surveyors from the Consumer Product Safety Commission (CPSC) visited homes, they found that one third of the smoke detectors were inoperable. Some fire department surveys have found 40 percent of smoke detectors disabled.

One primary reason nuisance alarms were present was due to the owner failing to routinely clean the smoke detectors. The accumulation of dust particles or other particulate matter within the detection chamber can have a detrimental impact on the performance of a detector. Such particles may elevate the reflected light values measured by a lens or sensor in the detector, so that the increased level of reflected light effectively lowers the particulate concentration in the ambient air that will likely trigger an alarm event and increase the possibility of a false alarm. For commercial detectors, false alarms have the potential to unnecessarily cause the evacuation of a building and are highly undesirable. The accumulation of such particulate matter in the detection chamber requires the eventual cleaning or replacement of the detection chamber to maintain the smoke detector in proper working order. The cleaning of a conventional detector typically requires the disassembly of the detector to expose and gain access to any detection lenses. After opening up the detector, pressurized air is usually used to clean the lenses. The disassembly and re-assembly of the detector for cleaning purposes can result in damage to various parts of the detector (which usually includes technology such as a printed circuit board). Oil or lotion from the cleaner's hand may also contaminate the detector lenses. All of these factors may result in the increase cost of maintaining or otherwise replacing the detectors.

Further, an earlier study of home smoke detection as units in an Automatic Remote Residential Alarm System (ARRAS) in The Woodlands, Tex., found 27.0 unwanted activations for every real alarm, or unwanted activations in six of every seven homes each year. While both studies identified a number of steps that could be taken to sharply reduce the rate of unwanted alarm activations from the detectors, the current rate is so high that neither study expects unwanted activations can be made less frequent than real smoke activations. Thus, nuisance activations may continue to induce owners to deactivate their smoke alarms.

The disconnected or missing battery problem is also closely linked to the nuisance activation problem. If these activations were reduced, it would also reduce the possibility that people will assume all smoke alarm activations are nuisance alarms because of the very high percentage that are. Nuisance activations can be addressed by more frequent or effective alarm cleaning. Until the present invention, it is believed that there has not been an apparatus, system or method which would adequately address this problem and solve this problem in the industry.

The prior art has attempted to solve the problem of cleaning lenses in detectors. For example, U.S. Pat. No. 4,672,217 discloses a smoke detector which is cleaned by physically removing the cover of the detector, thereby exposing the lenses for cleaning. This disclosure requires the disassembly of the detector, which may be time consuming or otherwise might affect the functionality of the detector. U.S. Pat. No. 7,034,702 discloses a complicated optical smoke detector having numerous mechanical valves, ports and apertures which are designed to receive pressurized air from an air nozzle in order to clean the detector. This invention is mechanically complicated, costly and requires a positive (e.g., forward moving) pressurized air in order to clean the detector (from a device that is usually not owned by most households, unlike a vacuum cleaner which is owned by most households). The present invention overcomes the problems not solved by the prior art, without the need for positive pressurized air or the need for any cleaning brushes or like devices.

The present invention provides an elegant solution for many of these problems, without mechanical complexity. One advantage of the present invention is that it does not require the disassembly of the detector when removing particulates from the detector. Using the present invention, the time to clean a detector is thus substantially reduced, thereby leading to lower time and maintenance costs for cleaning a detector.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

In one embodiment, the present invention is a detector cleaner which may be generally defined as having a funnel structure with an integrally formed wide surface area on one end, and an integrally formed narrow surface area on the opposite end, the funnel structure further having an interior void V or funnel channel where the wide area of the funnel structure is adapted to be placed over a detector to thereby completely encapsulate the detector. The narrow area of the funnel structure is adapted to be connectable to a suction means (such as a vacuum machine). Preferably, one or more angled holes are formed variously on the funnel structure so that when the suction means is engaged, the exterior air or other fluid flowing through each angled hole will dramatically enter the interior of the funnel to thereby create a significant fluid cyclone or swirling effect within the interior chamber of the funnel structure.

This disclosure describes numerous specific details that include specific structures and elements, their particular arrangement, and their particular functions in order to provide a thorough understanding of the present invention. One skilled in the art will appreciate that one may practice the present invention without the specific details.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1 is a side perspective view of one embodiment of the present invention, illustrating an exemplary vacuum connection VC coupled to this embodiment, and further illustrating the invention encapsulating a detector D;

FIG. 2 is side plan view of the present invention illustrating an exemplary vacuum connection VC coupled to the invention, and further illustrating the invention as it encapsulates an exemplary detector D, the dashed lines illustrating an exemplary fluid cyclone or swirling effect within the funnel structure of the present invention;

FIG. 3 is another side plan view of the present invention;

FIG. 4 is a top side plan view of the embodiment shown in FIG. 3;

FIG. 5 is a bottom side plan view of the embodiment shown in FIG. 3; and

FIG. 6 is another side perspective view of one embodiment of the present invention within an exemplary vacuum connection VC coupling.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

The present invention may be embodied as a method, system, an apparatus or a device. Other variations and modifications of the present invention will be apparent to those of ordinary skill in the art, and is not limited except by the appended claims. The particular values and configurations discussed above may be varied, and are cited to illustrate particular embodiments of the present invention. It is contemplated that the use of the present invention can involve components having different characteristics as long as the principles disclosed herein are followed.

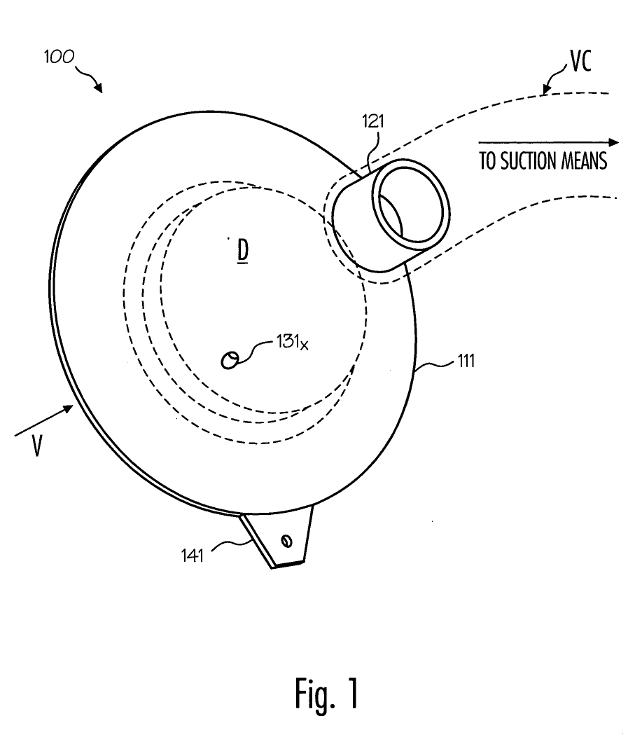

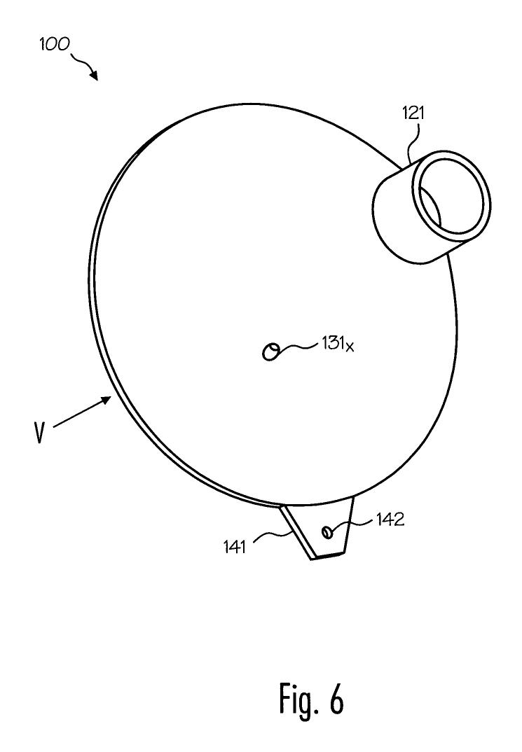

As exemplary illustrated in the attached pictures and illustrations (FIGS. 1-6), the present invention is, in one embodiment, a cleaning apparatus for detectors. The present invention may also be defined as a method for cleaning detectors, as well as a system for cleaning detectors.

The present invention is a cleaning apparatus 100 adapted to clean a detector without disconnecting the detector from its mounting position (e.g., typically, the mounting position is on a horizontal ceiling or vertical wall).

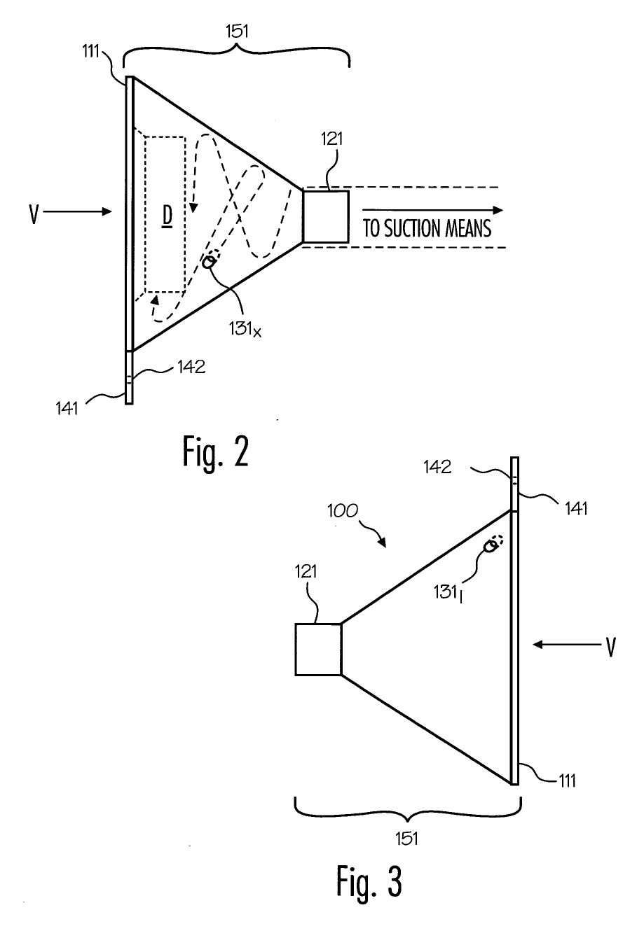

The present invention may be generally defined as a generally funnel structure 151 having an integrally formed wide open-mouth surface area 111 on one end which is preferably dimensionally larger than the diameter or shape of a detector, and an integrally formed narrow open-mouth surface area 121 on the opposite end, the funnel structure 151 further having an interior void V or funnel channel (as shown in FIGS. 2, 3 and 7, for example), where the wide area 111 of the funnel structure 151 is adapted to be placed over the detector D (as seen in FIG. 2) to thereby completely encapsulate the detector within the interior void V. The narrow area 121 of the funnel structure 151 is preferably a projected portion, and is adapted to be removably connectable to a suction means (such as, for example, a vacuum machine having an universal vacuum connection or hose VC as indicated in FIGS. 1 and 2, for example). In one embodiment, the present invention may also include the apparatus 100 coupled with a suction means (not shown in the drawings, but well known to those of skill in the art), so that any air suction pressure created by or arising from the suction means is in fluid flow communication with the air pressure within the interior void V.

Notably, at least one or more angled holes 131ₓ (where x=1, 2, 3, etc.) may formed on the funnel structure 151 at one or more predefined surface sections of the funnel structure. In this example, when the suction means is engaged, the exterior air or other fluid flowing through each angled hole 131ₓ will enter the interior of the funnel to thereby create a significant fluid cyclone or swirling effect (as represented, for example, by the dashed lines in FIG. 2) within the funnel structure's 151 interior void V when suction is applied to the vacuum connection, the cyclone or swirling effect of the fluid being adapted to optimally swirl through one or more openings in the encapsulated detector D and any sensing lenses therein, thereby cleaning all structures within the detector D. Those of skill in the art will recognize that some of the holes may not be formed at an angular position variously through or on the funnel structure, while other holes may be formed at without any angular position.

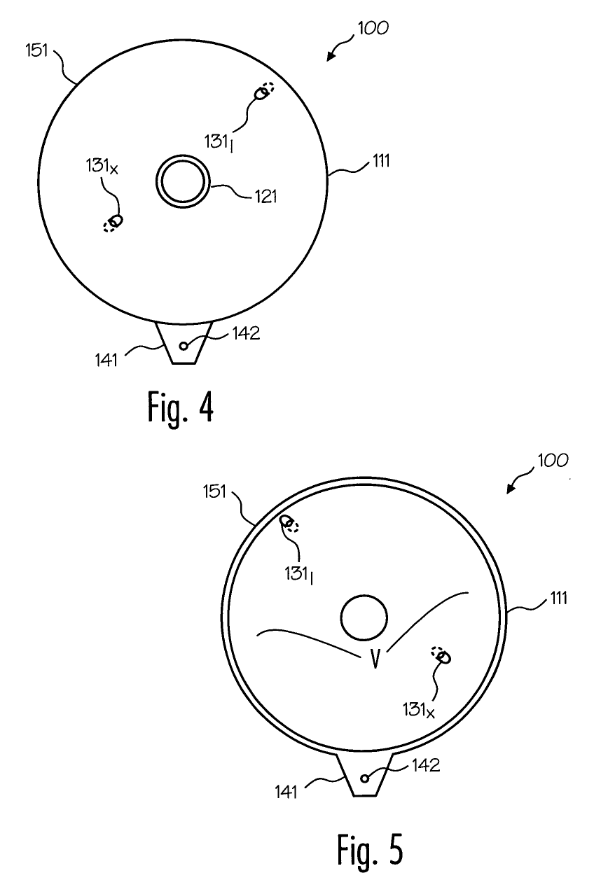

In one embodiment of the present invention, at least two holes 131₁, 131ₓ are formed on and through the funnel structure. Thus, for example, a first hole 131₁ at the opening is formed at a 45 degree upward direction from the opening (as illustrated, for example, in FIG. 1). A second hole 131ₓ may be formed approximately midway up the side of the funnel structured (as seen for example, in FIGS. 4 and 5). Preferably, each hole is formed at a 45 degree angle. Optionally, each hole may be formed to create an opening having an approximately three-eighths of an inch diameter. In another preferred embodiment, each hole is formed in predefined angles and directions (such as, for example, at a downward direction from any adjacent hole, or, each hole being formed in a different direction than any other hole). The two holes may also be formed on the same alignment plane on the funnel structure. In any event, any holes formed are preferably formed in different areas of the funnel structure in order to optimize the cyclone effect within the interior void V of funnel structure 151 in relation to the amount of suction being produced through the vacuum connection by the suction means.

While most conventional detectors are round, those of skill in the art will realize that other exterior shapes of detectors are possible (e.g., square, rectangular, triangular, or other various external shapes) and are merely a design choice. While the present invention preferably discloses a round funnel structure for encapsulating a round detector, the funnel structure may similarly be redesigned to fit or otherwise encapsulate other shapes of detectors (e.g., a square funnel structure, a rectangular funnel structure, a triangular funnel structure, etc.) in accordance with the various teachings of this invention.

In another embodiment of the present invention, the narrow area 121 of the funnel structure may be adapted to connect to flexible or swivel vacuum connection, which may be useful for cleaning detectors which are difficult to reach (such as, for example, on an angled wall). Alternatively, in still another embodiment of the present invention, the narrow area 121 of the funnel structure may be adapted to connect to a rigid, but straight, vacuum connection, which may be useful for cleaning detectors which are difficult to reach (such as, for example, on a tall ceiling).

Optionally, the wide area of the funnel structure may contain a storage section which is generally defined as a protruding section 141 having an attachment aperture, the aperture which is adapted to receive a hook, nail or other item for easily storing the entire present invention on a wall, work bench or like storage surface.

It should be appreciated that the particular implementations disclosed herein are illustrative of the invention and its best mode, and are not intended to otherwise limit the scope of the present invention in any way. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

As those of skill in the art will now realize, the present invention is easy to use during operation. Thus, for example, a suction connection (attached to the suction means) may be removably coupled to the narrow area of the funnel structure, and the wide area of the funnel structure is placed over the detector and thereby completely encapsulate the detector (so that the wide area of the funnel structure is flush with the wall). When the suction is applied from the suction means, the exterior air or other fluid flowing through each angled hole will enter the interior of the funnel structure 151, and thereby create a significant cyclone or swirling effect within the funnel structure's interior. In this fashion, the cyclone or swirling effect of the fluid will swirl throughout the detector D, the detector's underside, the detector's surface, and through the detectors grills and all detector openings, thereby cleaning all structures (including detector sensors or lenses) within the detector D, without harming the function of the detector. Preferably, this operation will take less than 15 seconds. After cleaning for a short amount of time, the vacuum may be disengaged from the detector D, and the invention 100 can then be removed from encapsulating the detector D.

It is believed that in order to achieve optimize cleaning performance, the invention 100 should be placed so that hole 131₁ is located adjacent and below to the primary vent hole on the detector (if on a ceiling, for example). For wall mounted detectors, the hole 131₁ in the funnel should be placed directly in front of the detector vent.

The foregoing description of the preferred embodiments of the invention has been presented for the purposes of illustration and description. Other variations and modifications of the present invention will be apparent to those of ordinary skill in the art, and is not limited except by the appended claims. The particular values and configurations discussed above can be varied, and are cited to illustrate particular embodiments of the present invention. It is contemplated that the use of the present invention can involve components having different characteristics as long as the principles disclosed herein are followed.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

I claim:

1. A mounted detector cleaner apparatus, the apparatus comprising a funnel structure with a wide surface area on one end of the funnel structure, a narrow surface area on an opposite end of the funnel structure, and at least one or more one or more holes formed variously through the funnel structure, the funnel structure further having an interior void, the wide surface area of the funnel structure being adapted to be placed over a mounted detector to thereby completely encapsulate the detector, the narrow surface area of the funnel structure being adapted for removable coupling to a suction means, the apparatus adapted to allow exterior air flowing through each hole to enter the void when the suction means is engaged to thereby create a fluid cyclone or swirling effect within the interior chamber of the funnel structure.

2. The apparatus of claim 1 wherein the holes are angled at predetermined angles and locations on the funnel structure to optimally allow the fluid to swirl through one or more openings in the encapsulated detector.

3. The apparatus of claim 1 wherein the large surface area is open-mouthed and the narrow surface area is open-mouthed.

4. The apparatus of claim 1 wherein the funnel structure is further defined by having the large surface area being integrally formed with the funnel structure, and further defined by having the narrow surface area being integrally formed with the funnel structure.

5. The apparatus of claim 1 wherein air suction pressure created by the suction means is in fluid flow communication with the air pressure within the interior void.

6. The apparatus of claim 5 wherein the narrow surface area is adapted to be removably coupled to a vacuum connection.

7. The apparatus of claim 6 wherein the vacuum connection is fluidly connected to a suction means.

8. The apparatus of claim 7 wherein the suction means is a vacuum cleaner.

9. The apparatus of claim 1, the wide surface area further comprising a protruding section having an attachment aperture, the aperture being adapted to receive an item for hanging the apparatus on a surface.

10. A kit for cleaning a detector, the kit comprising a funnel structure and a suction means, the funnel structure having a wide surface area on one end of the funnel structure, a projected narrow surface area on an opposite end of the funnel structure, and at least one or more one or more angled holes formed variously through the funnel structure, the funnel structure further having an interior void, the wide surface area of the funnel structure being adapted to be placed over a mounted detector to thereby completely encapsulate the detector, the narrow surface area of the funnel structure being adapted for removable coupling to the suction means through a vacuum connection, the kit adapted to allow exterior air flowing through each hole to enter the void when the suction means is engaged to thereby create a fluid cyclone or swirling effect within the interior chamber of the funnel structure.

11. The kit of claim 10 wherein the holes are angled at predetermined angles and locations on the funnel structure to optimally allow the fluid to swirl through one or more openings in the encapsulated detector.

12. The kit of claim 10 wherein the funnel structure is further defined by having the large surface area being integrally formed with the funnel structure and further defined by having the narrow surface area being integrally formed with the funnel structure.

13. The kit of claim 10 wherein air suction pressure created by the suction means is in fluid flow communication with the air pressure within the interior void.

14. The kit of claim 10 wherein the suction means is a vacuum cleaner.

15. A method for cleaning a mounted detector, the method comprising the steps of:
Introducing a device comprising a funnel structure with a wide surface area on one end of the funnel structure, a narrow surface area on an opposite end of the funnel structure, and at least one or more one or more holes formed variously through the funnel structure, the funnel structure further having an interior void;
placing the funnel structure over the mounted detector to thereby completely encapsulate the detector;
coupling the narrow surface area of the funnel to a suction means; and
engaging the suction means to allow exterior air flowing through each hole to enter the void to thereby create a fluid cyclone or swirling effect within the interior chamber of the funnel structure to allow the air to swirl through one or more openings in the encapsulated detector.

16. The method of claim 15 wherein the holes are angled at predetermined angles and locations on the funnel structure to optimally allow the fluid to swirl through one or more openings in the encapsulated detector.

17. The method of claim 15 wherein air suction pressure created by the suction means is in fluid flow communication with the air pressure within the interior void.

18. The method of claim 17 wherein the suction means is a vacuum cleaner.

19. The method of claim 15 wherein the wide surface area further comprising a protruding section having an attachment aperture, the aperture being adapted to receive an item for hanging the apparatus on a surface.

20. The method of claim 15 wherein the funnel structure is further defined by having the large surface area being integrally formed with the funnel structure, and further defined by having the narrow surface area being integrally formed with the funnel structure.
